(19) United States
(12) Patent Application Publication
(10) Pub. No.: US 2008/0208748 A1
(43) Pub. Date: Aug. 28, 2008

(54) Transaction system and method

(76) Inventors: Frank Ozment, Mountain Brook, AL (US); Clay Daniel, Helena, AL (US); Dewayne Jones, Birmingham, AL (US)

Correspondence Address: STEPTOE & JOHNSON LLP, 1330 CONNECTICUT AVENUE, N.W., WASHINGTON, DC, 20036, US

(21) Appl. No.: 11/958,130

(22) Filed: Dec. 17, 2007

Related U.S. Application Data
(60) Provisional application No. 60/871,572, filed on Dec. 22, 2006.

(51) Int. Cl. G06Q 40/00

(52) U.S. Cl. 705/44; 705/35

(57) ABSTRACT

A transaction system having security parameters can authorize transactions based on a merchant category code, a card verification value code, a geographic location, a monetary value range, a transaction mode, an account access parameter, a class of goods, or a class of services, for example.

### CLAIM FOR PRIORITY

This application claims priority under 35 U.S.C. § 119(e) to U.S. Patent Application Ser. No. 60/871,572, filed on 22 Dec. 2006, which is hereby incorporated by reference in its entirety.

### TECHNICAL FIELD

The invention relates to the field of transaction systems.

### BACKGROUND

A transaction system including a transaction card can be provided wherein a decision to grant or deny a transaction request is in the control of an issuer of a transaction card. This decision can be made based on a merchant category code, a class of goods, or a class of services, for example. Issuers of the transaction card can encode information on the transaction card to permit the evaluation of each transaction request at a terminal.

### SUMMARY

In general, a method for controlling financial transactions can include establishing a security parameter to debit an account, issuing a transaction card to a user, the transaction card carrying data identifying the security parameter, receiving a transaction request, the transaction request characterized by a transaction parameter, comparing the transaction parameter to the security parameter to evaluate the transaction request, and determining whether to process the transaction request.

A transaction security system can include a transaction card for an account, the account funded by a source and issued to a user, the card carrying security parameters, a terminal at a point of transaction, the terminal configured to initiate a transaction request, the request having transaction parameters, and a processor configured to receive funds, establish security parameters, receive transaction parameters and evaluate transaction requests based on a comparison of security parameters and transaction parameters.

In certain circumstances, the account can be designed to compensate for uninsured losses, such as the uninsured losses of a disaster victim. The account can be allocated for disaster relief, and can be funded by a source. In one embodiment, the source can be a federal, state or local government agency.

A security parameter can be, for example, a merchant category code, a card verification value code, a geographic location, a monetary value range, a transaction mode, an account access parameter, a class of goods, or a class of services.

In other embodiments, the system can be configured to provide notice of whether the request has been granted or denied to a user. The system can be configured to adjust a security parameter for a predetermined period of time. The system can be configured to permit the transfer of funds from the account. The system is configured to permit the transfer of funds to the account. The system can be configured to charge a fee for the use of the transaction card.

In another embodiment, the transaction card can be part of one network. Alternatively, a transaction card can be part of a plurality of networks.

In certain circumstances, the system can be configured to secure an agreement from a merchant regarding a geographic location, a monetary value range, a transaction mode, an account access parameter, a class of goods, or a class of services, before establishing a security parameter. The system can also be configured to require certification for a transaction request. The system can be configured to permit the placement of additional funds to the account.

Other features, objects, and advantages of the invention will be apparent from the description and drawings, and from the claims.

### DESCRIPTION OF THE DRAWINGS

FIG. 1 depicts a system diagram.

### DETAILED DESCRIPTION

A method for controlling transactions can include establishing a security parameter to debit an account. The account can be designed to compensate for uninsured losses. The account can be allocated for disaster relief, and can be funded by a source. In one embodiment, the source can be a federal, state or local government agency. The source can also be a lender, a relief organization, foundation, or other institution willing to participate in a disaster relief program, for example.

The source provides an initial amount of funds for disbursement to a user through a financial institution. A user is a customer, purchaser, cardholder, account manager, or agent having responsibility for the transaction. A user's identity can be verified by personalized parameters. A user can be a victim of a disaster, such as a hurricane, flood, earthquake, fire, war, or other disaster. The account can be designed to compensate for a user's uninsured losses, such a loss of a home, dwelling, or other property. The financial institution can be an issuer of a transaction card, for example.

A transaction system having security parameters can include a transaction card, a terminal at a point of transaction, the terminal configured to initiate a transaction request, and a processor that regulates transactions based upon a predetermined set of security parameters specified by a financial institution, such as an issuer of a card.

A security parameter can be merchant category code, a geographic location, a monetary value range, a transaction mode, an account access parameter, a class of goods, or a class of services. In other embodiments, the system can be configured to provide notice of whether the request has been granted or denied to a user. The notice can be provided at a terminal at a point of transaction, for example.

The transaction system can be configured to adjust a security parameter for a predetermined period of time. For example, depending on the state of need, a transaction system may be configured to change or reduce the number of security parameters in order to provide faster relief. A transaction system may also be configured to change or increase the number of security parameters, for example, if fraud is suspected.

The system can be configured to adjust a security parameter for each user at any time on a case by case basis. Alternatively, the system can be configured to adjust security parameters for a group of users, or for all users at one time.

The system can be configured to permit the transfer of funds from the account. The system can be configured to permit the transfer of funds to the account. The system can be configured to charge a fee for the use of the transaction card.

The transaction card can be a prepaid card. The card can be configured to transfer funds from an account owned by a source other than an authorized cardholder. The source can load the card with funds and monitor transactions made with the card. In one example, funds from the account can be debited from an account owned by a federal, state, or local government. The user can have access to this account within predetermined security parameters up to a preset spending limit. The system can be configured such that funds allocated for disaster relief are protected against garnishment, attachment, seizure, and levy, for example, by maintaining the account in the name of the source, rather than in the name of the user or disaster victim. For example, if a user is a disaster victim, creditors of a disaster victim will not have a lien on the account.

In another example, a source has the option to open an account in the name of the user. In this situation, the transaction card would debit an account, which is held by the user. If the card is ever lost or stolen, the system can be configured such that the user is not responsible for any unauthorized purchases.

The system can be used in conjunction with a documentary draft or other negotiable instruments. A documentary draft can be a documentary draft as described under Article 5, Section 103 of the Uniform Commercial Code. A documentary draft can be a draft that is conditioned upon the presentation of a document. A document can include any paper including document of title, security, invoice, certificate, notice of default or similar paper.

In another embodiment, the transaction card can be part of one network. For example, a transaction card can be part of a VISA network exclusively, which can make the account easier to monitor and can increase security. Alternatively, a transaction card can be part of a plurality of networks, such as VISA network, STAR network, CITI network, or Cirrus network. A transaction card can be part of a plurality of networks to provide enhanced accessibility.

In certain circumstances, the system can be configured to secure an agreement from a merchant regarding a geographic location, a monetary value range, a transaction mode, an account access parameter, a class of goods, or a class of services, before establishing a security parameter. A merchant can be a provider of goods or services, a buyer or seller of commodities, or an operator of a retail business. A merchant can be a provider that is noted for a particular class of goods, service, or activity.

The transaction system and method can be part of a program wherein a source provides funding to victims of a disaster. As a part of the program, the financial institution may certain merchants or classes of merchants, who have been pre-approved for transactions. Pre-approval can be determined by the financial institution based on the merchant category code, class of goods sold, class of services provided, or other information. In certain circumstances, the financial institution can form a network of pre-approved merchants who can participate in the program. A financial institution may elect to form agreements with particular merchants or classes of merchants regarding a geographic location, a monetary value range, a transaction mode, an account access parameter, a class of goods, or a class of services, before establishing a security parameter. As a condition for participating in the program or network, a financial institution may require that the pre-approved merchants agree to the conditions established by the financial institution regarding a geographic location, a monetary value range, a transaction mode, an account access parameter, a class of goods, or a class of services, before establishing a security parameter, for example.

In another embodiment, the system can also be configured to require certification for a transaction request. In this case, the system can require a merchant or a user to provide certification such as a receipt, affidavit, or other documentation, that details the nature of the transaction for security purposes, or if an audit should become necessary, for example.

The system can be configured to permit the placement of additional funds to the account. The account can be reloaded by any known means, such as by check, fund transfers, cash deposits, or electronic deposits.

A card can be a transaction card, such as a prepaid debit card or a credit card. The card can include a magnetic stripe, chip, or other computer-readable storage medium. The card can include a parameter such as a security parameter that can be used in determining whether to authorize a transaction.

A card issuer, such as a financial institution, specifies the security parameter for a transaction. The security parameter may include, but is not limited to a merchant class code (MCC), a card verification value code (CVV), a geographic location, a monetary value range, a transaction mode, an account access parameter, a class of goods, or a class of services. A merchant class code can restrict transactions based on the types of goods or services provided (i.e. restaurants, hotels, clothing, etc.). The financial institution may vary these security parameters at any time. The financial institution may specify certain security parameters for a predetermined amount of time. The transaction may include, but is not limited to financial transactions and account access transactions.

The financial institution may specify these user security parameters at the outset of acquiring an account for conducting transactions, or at any time thereafter. The transaction system can use these security parameters to control or screen subsequent transactions. When transactions contain indicia outside of the authorized security parameters, the transaction system may either warn the user with a warning message and allow the transaction, or the transaction system may block the transaction with our without sending a warning message. The transaction system allows transactions that comport with the security parameters.

A processor controlled by a financial institution can be configured to receive funds, establish security parameters, receive requests having transaction parameters from a terminal, and evaluating transaction requests based on a comparison of security parameters and transaction parameters.

A source, such as a federal, state, or local government agency can allocate funds to a financial institution by way of communication lines, for example, to provide relief to disaster victims. A financial institution can open designated accounts for these funds. A processor can associate each account with a transaction card, which can then be distributed to a user or cardholder. An account associated with a card can maintain a security interest held by a source other than the user.

A transaction system can screen against fraudulent transactions by establishing a security parameter to verify the identity of the user when using the card. The system can also establish security parameters such as a merchant category code, a card verification value code, a geographic location, monetary value ranges, transaction modes, account access parameters, classes of goods, or classes of services. These security parameters can be encoded on a transaction card.

In one example, the financial institution may select, as a security parameter, a class of merchants that sell goods for home repair, construction equipment, groceries, and medical supplies. A transaction request can be initiated by any of the pre-approved class of merchants whose terminals are configured to generate a transaction parameter. The financial institution, through a processor, can then compare the transaction parameter to the security parameter. If a match is found, the financial institution can authorize the transaction request, and proceed to transfer the requested funds.

The financial institution may also select a security parameter by which to block transactions. For example, the financial institution may select, as a security parameter, a class of merchants that sell luxury items, liquor, tobacco products, pharmaceuticals, or entertainment goods. If a transaction request is initiated by any of the blocked merchants, the transaction request can also be characterized by a transaction parameter at a terminal. The financial institution, through a processor, can then compare the transaction parameter to the security parameter, and deny a transaction request.

As an additional security measure, a financial institution can require certification for a transaction request. Based on review of the certification, a financial institution can grant, deny, cancel, or demand repayment from a transaction request.

A financial institution can create a fee structure in which a monthly fee or transactional fee can cover the costs of the program. The source of funding, such as a federal, state, or local government agency, can bear the costs or fees associated with the account. Alternatively, the costs and fees can be charged to the user. Costs can include customer support, network expense, card creation costs, or other transactional costs.

A card can be funded by automated clearing house in which a user can transfer funds by instructing the user's financial institution to debit his or her account and credit another account. This transfer is initiated by the user through his or her financial institution. The card can be reloaded if necessary at any time by the user, such as by reallocating checks. A card can bear a brand indicating the network to which the card belongs. For example, the card can be a VISA brand card, limiting the card to the VISA network. A card can be part of one network exclusively. Alternatively, a card can be a part of a plurality of networks, such as a VISA network, STAR network, CITI network, or Cirrus network. A transaction card can be part of a plurality of networks to provide enhanced accessibility.

The financial institution may also select an amount of funds as a security parameter, such as a daily limit for a maximum debit of funds. The financial institution may further select a security parameter in which to send a notice to the user. In addition to utilizing the user security parameters, the system can include other fraud-prevention measures, such as analyzing the transaction parameter with a neural network. Fraud prevention systems are described, for example, in U.S. application Ser. No. 11/464,143, which is incorporated by reference herein.

A financial institution may specify certain security parameters for a predetermined amount of time only. For instance, the financial institution may configure a processor to allow transactions from a particular geographic location that has experienced a regional disaster to facilitate home repair or home payment only in that region.

A transaction may include, but is not limited to financial transactions and account access transactions. When transactions contain indicia outside of the user security parameters, the fraud-prevention system may either warn the user or financial institution with a warning message and allow the transaction, or the fraud-prevention system may block the transaction with our without sending a warning message.

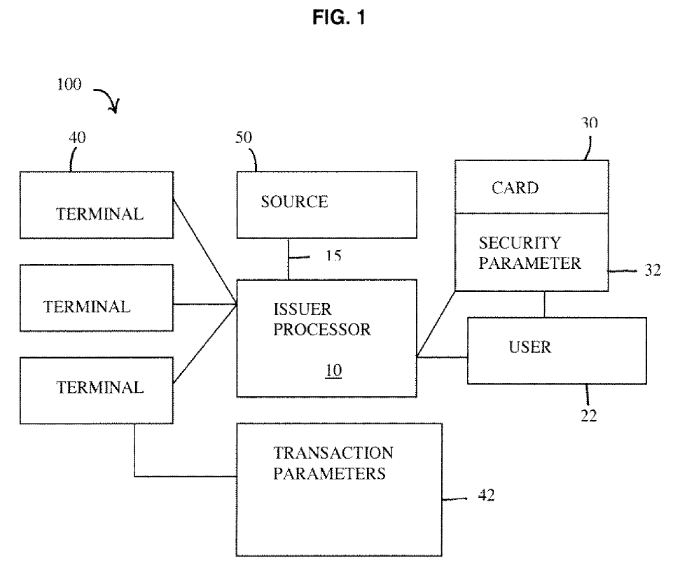

Referring to FIG. 1, a transaction system 100 is shown. A source 50 provides funds through a communication line 15 for an account with a financial institution, who disburses funds to a user, such as a cardholder 22. A financial institution can be a card issuer having a processor 10 connected via communication lines 14 to a plurality of transaction terminals 40. The terminals 40 are located at the point of the transaction. A transaction card 30 can include security parameters 32. A terminal can have transaction parameters 42, which can be compared to the security parameters, before a card issuer makes a decision whether or not to authorize a transaction request from a particular merchant.

A user can present his or her card to a merchant. The merchant can run the card through the terminal enabling the terminal to read the information on the card. This information can include security parameters. The merchant can then enter a transaction request including a transaction amount, and this information can then be transmitted along communications line to the issuer. The card issuer, through a processor, can then compare the transaction parameters sent by the terminal with the security parameters stored in the card.

A processor can be programmed to provide a comparison function for evaluating the transaction based upon the security parameters and the transaction parameters. If the evaluation was favorable, an approval code can be sent back to the merchant, who would complete the transaction. If the evaluation was unfavorable, the transaction can be declined. Other methods of transaction risk assessment are described, for example, in U.S. Pat. No. 4,734,564, which is incorporated by reference herein.

The various techniques, methods, and systems described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer may have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs may be installed on the internal or external storage of the general-purpose computer. Alternatively, in another implementation, application programs may be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol or HTTP). The selected page is then displayed to the user on the client's display screen. The client may then cause the server containing a computer program to launch an application to, for example, perform an analysis according to the described techniques. In another implementation, the server may download an application to be run on the client to perform an analysis according to the described techniques.

Although the systems and methods have been described in detail, it will be apparent to those of skill in the art that the systems and methods may be embodied in a variety of specific forms and that various changes, substitutions, and alterations can be made without departing from the spirit and scope of the systems and methods described herein. The described embodiments are only illustrative and not restrictive and the scope of the systems and methods is, therefore, indicated by the following claims. Other embodiments are within the scope of the following claims.

What is claimed is:

1. A method for controlling financial transactions, comprising:
establishing a security parameter to debit an account;
issuing a transaction card to a user, the transaction card carrying data identifying the security parameter;
receiving a transaction request, the transaction request characterized by a transaction parameter;
comparing the transaction parameter to the security parameter to evaluate the transaction request; and
determining whether to process the transaction request.

2. The method of claim 1, wherein the account is designed to compensate for uninsured losses.

3. The method of claim 1, wherein the account is allocated for disaster relief.

4. The method of claim 1, wherein the account is funded by a source.

5. The method of claim 4, wherein the source is a federal, state or local government agency.

6. The method of claim 1, wherein the security parameter is merchant category code, a card verification value code, a geographic location, a monetary value range, a transaction mode, an account access parameter, a class of goods, or a class of services.

7. The method of claim 1, further comprising providing notice of whether the request has been granted or denied to a user.

8. The method of claim 1, further comprising temporarily adjusting the security parameter for a predetermined period of time.

9. The method of claim 1, further comprising permitting the transfer of funds from the account.

10. The method of claim 1, further comprising permitting the transfer of funds to the account.

11. The method of claim 1, further comprising charging a fee for the use of the transaction card.

12. The method of claim 1, wherein the transaction card is part of one network.

13. The method of claim 1, wherein the transaction card is part of a plurality of networks.

14. The method of claim 1, further comprising securing an agreement from a merchant regarding a geographic location, a monetary value range, a transaction mode, an account access parameter, a class of goods, or a class of services, before establishing a security parameter.

15. The method of claim 1, further comprising requiring certification for a transaction request.

16. The method of claim 1, further comprising placing additional funds to the account.

17. A transaction security system, comprising:
a transaction card for an account, the account funded by a source and issued to a user, the card carrying security parameters;
a terminal at a point of transaction, the terminal configured to initiate a transaction request, the request having transaction parameters; and
a processor configured to receive funds, establish security parameters, receive transaction parameters and evaluate transaction requests based on a comparison of security parameters and transaction parameters.

18. The method of claim 17, wherein the account is designed to compensate for uninsured losses.

19. The system of claim 17, wherein the account is allocated for disaster relief.

20. The system of claim 17, wherein the account is funded by a source.

21. The system of claim 19, wherein the source is a federal, state or local government agency.

22. The system of claim 21, wherein the security parameter is merchant category code, a card verification value code, a geographic location, a monetary value range, a transaction mode, an account access parameter, a class of goods, or a class of services.

23. The system of claim 17, wherein the system is configured to provide notice of whether the request has been granted or denied to a user.

24. The system of claim 17, wherein the system is configured to adjust the security parameter for a predetermined period of time.

25. The system of claim 17, wherein the system is configured to permit the transfer of funds from the account.

26. The system of claim 17, wherein the system is configured to permit the transfer of funds to the account.

27. The system of claim 17, wherein the system is configured to charge a fee for the use of the transaction card.

28. The system of claim 17, wherein the transaction card is part of one network.

29. The system of claim 17, wherein the transaction card is part of a plurality of networks.

30. The system of claim 17, wherein the system is configured to secure an agreement from a merchant regarding a geographic location, a monetary value range, a transaction mode, an account access parameter, a class of goods, or a class of services, before establishing a security parameter.

31. The system of claim 17, wherein the system is configured to require certification for a transaction request.

32. The system of claim 17, wherein the system is configured to permit the placement of additional funds to the account.
